(19) United States
(12) Patent Application Publication
(10) Pub. No.: US 2026/0193897 A1
(43) Pub. Date: Jul. 9, 2026

(54) ADAPTABLE POOL CLEANING ROBOT

(71) Applicant: BWT ROBOTICS POOL & SPALTD., Afula (IL)

(72) Inventors: Eyal BAREL, Tirat Hacarmel (IL); Evgeny ADLIVANKIN, Haifa (IL); Efraim GARTI, Zichron Yaakov (IL)

(73) Assignee: BWT ROBOTICS POOL & SPALTD., Afula (IL)

(21) Appl. No.: 19/128,561

(22) PCT Filed: Nov. 7, 2023
(86) PCT No.: PCT/IL2023/051141

§ 371 Date: May 9, 2025

Related U.S. Application Data
(60) Provisional application No. 63/424,174, filed on Nov. 10, 2022.

(51) Int. Cl. E04H 4/16; C02F 1/00; C02F 103/42; G05D 1/648; G05D 105/10; G05D 107/00

(52) U.S. Cl. CPC E04H 4/1654; C02F 1/001; C02F 1/008; G05D 1/648; C02F 2103/42; C02F 2209/006; C02F 2209/42; G05D 2105/10; G05D 2107/29

(57) ABSTRACT

A pool cleaning robot apparatus comprising: a housing; a pump for drawing liquid from the pool into the housing through an inlet and expelling the liquid through an outlet when the pool cleaner is submerged in the pool; a filter for trapping debris that is in the indrawn liquid; a propulsion system for propelling the pool cleaning robot along a submerged surface within the pool; and a control system configured to: detect a type of a power source when connected to the power source, the type being either a main electricity driven power source or a rechargeable battery, and based on the identified type of the power source, select an operation mode for the pool cleaning robot associated with the identified type of the power source.

### TECHNICAL FIELD OF THE INVENTION

The present invention relates generally to swimming pool cleaners, and in particular to adaptable pool cleaning robots.

### BACKGROUND OF THE INVENTION

In many swimming pools, pool cleaning robots are often employed for routine pool cleaning and maintenance. Commonly, a pool cleaning robot is connected to mains electricity supply by a buoyant cable with a plug that is plugged into a socket located outside the pool. During operation, when the robot travels along the floor surface and wall surfaces of the pool, the cable may become entangled, restricting the robot from efficiently scanning the pool and may require unravelling of the cable by a user during or after operation. Indeed, after pool cleaning operation by a pool cleaning robot twisted cables may frequently be observed, in particular in the case of swimming pools having round shapes and corners.

Alternatively, some pool cleaning robots are powered by rechargeable batteries located within their housing instead of being powered by a mains electricity supply. However, these pool cleaning robots are typically heavier than pool cleaning robots powered by the mains electricity supply due to the weight of the internal battery and, thus, removal of these robots from a pool, e.g. for service, or to enable swimmers to get in the pool, is challenging. Another configuration of pool cleaning robots includes a buoyant rechargeable battery configured to float on the surface of the pool and linked to the submerged body of the pool cleaning robot via a cable whose length is fit to match the depth of the pool at its deepest end.

Present pool cleaning robots are powered either by the mains electricity or by rechargeable batteries. None of the state of the art pool cleaning robots provides for a hybrid system that allows supply of electricity to the pool cleaning robot via either mains electricity or via rechargeable batteries and comprises an auto-adapting control system that adapts the operation mode of the pool cleaning robot to the particular power supply and adapts the operation mode to the presence of external devices once identified as electrically connected to the pool cleaning robot.

Thus, it may be desired to provide a pool cleaning robot that is connectable to either a battery power supply or a mains electricity power supply and includes a control system that is configured to automatically adapt the operation mode of that pool cleaning robot depending on the type of power supply that is connected to the robot and/or external devices connected to the pool cleaning robot.

### SUMMARY OF THE INVENTION

Disclosed herein is a pool cleaning robot that is configured to identify the type of power supply is connected to, when connected either to a mains electricity power supply or to a battery power supply. The pool cleaning robot disclosed herein can further adapt its operation mode depending on the identified type of power supply identified.

Advantages of the invention may include automatically adapting control parameters of the pool cleaning robot to the connected power source. Further advantages of the invention may include an improved handling of the robot by a user due to external buoyant batteries, reducing the weight of the components inside the housing. Further advantages of the invention may include an improved movement of the robot using an external buoyant battery on a short power supply cable that is less likely to entangle compared to a long power supply cable supplying the robot with energy from a main power supply source using a socket.

The following is a simplified summary providing an initial understanding of the invention. The summary does not necessarily identify key elements nor limit the scope of the invention, but merely serves as an introduction to the following description.

According to a first aspect, an embodiment of the present invention may provide a pool cleaning robot apparatus comprising: a housing; a pump for drawing liquid from the pool into the housing through an inlet and expelling the liquid through an outlet when the pool cleaner is submerged in the pool; a filter for trapping debris that is in the indrawn liquid; a propulsion system for propelling the pool cleaning robot along a submerged surface within the pool; and a control system configured to: detect a type of a power source when connected to the power source, the type being either a main electricity driven power source or a rechargeable battery, and based on the identified type of the power source, select an operation mode for the pool cleaning robot associated with the identified type of the power source.

According to an another aspect, an embodiment of the present invention may identify a method for adapting an operation mode for a pool cleaning robot, the method comprising: using a controller of the control system, identifying a type of a power source when connecting the pool cleaning robot to a power source, the type being either a main electricity driven power source or a rechargeable battery; and using the controller of the control system, based on the detected type of the power source selecting an operation mode for the pool cleaning robot associated with the identified type of the power source.

In another embodiment of the present invention, the control system is configured, in detecting the type of the power source, to perform one or more of: identify a serial communication received from the connected power source; detecting an input voltage received from the connected power source; and detecting a voltage sequence received from the connected power source.

In another embodiment of the present invention, the apparatus comprises a connection port and one or more of: serial communication, input voltage and voltage sequence of the connected power source, are received via the connection port.

In some embodiments, identifying a type of a power source comprises performing one or more of: identifying a serial communication received from the connected power source; detect an input voltage received from the connected power source; and detect a voltage sequence received from the connected power source.

In some embodiments, each operation mode is associated with a setting for one or more control parameters of the control system. In some embodiments, selecting the operation mode comprises adjusting one or more control parameters of the control system.

In some embodiments, the control parameters of the control system comprise one or more of: floor pump speed; floor drive motor; climbing pump speed; climbing wall frequency; climbing drive motor; climbing wall speed; water line scrubbing time; water line scrubbing intensity; cleaning time; proportional integral derivative (PID) control of drive motors; PID control of pump motors; wall climbing parameters; water line detection parameters; drain detection parameters; obstacle release process parameters; and scanning algorithm parameters.

In some embodiments, adjusting one or more control parameters of the control system comprises adjusting one or more of: floor pump speed; floor drive motor; climbing pump speed; climbing wall frequency; climbing drive motor; climbing wall speed; water line scrubbing time; water line scrubbing intensity; cleaning time; PID control of drive motors; PID control of pump motors; wall climbing parameters; water line detection parameters; drain detection parameters; obstacle release process parameters; and scanning algorithm parameters.

In some embodiments, the rechargeable battery is separate from the housing.

In some embodiments, the rechargeable battery is buoyant.

In some embodiments, the control system is configured to detect and identify external devices connected to the pool cleaning robot.

In some embodiments, the type of power source is identified at a connection port connected to the control system and the one or more of: serial communication, input voltage and voltage sequence of the connected power source, are received via the connection port.

In some embodiments, selecting the operation mode for the pool cleaning robot comprises adjusting one or more control parameters of: (a) operation cycle duration; (b) power consumption; and (c) floor time.

In some embodiments, selecting the operation mode for the pool cleaning robot comprises selecting the operation mode for one or more control parameters of the control system configured to control one or more of: propulsion system; water inlets; water outlets; filters; and pumps.

In some embodiments, the method further comprises using the controller of the control system, initializing, the adjusted control parameters.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, may be understood by reference to the following detailed description when read with the accompanied drawings. Embodiments are illustrated without limitation in the figures, in which like reference numerals indicate corresponding, analogous, or similar elements, and in which:

FIG. 1 is a block diagram of a pool cleaning robot apparatus, according to an embodiment of the present invention.

FIG. 2 is an illustration of a pool cleaning robot apparatus in a swimming pool connected to a mains electricity power source, according to an embodiment of the present invention.

FIG. 3 is an illustration of a pool cleaning robot apparatus in a swimming pool connected to a buoyant battery power source, according to an embodiment of the present invention.

FIG. 4 is a top view illustration of a pool cleaning robot apparatus and connected to a buoyant rechargeable battery power source, according to an embodiment of the present invention.

FIG. 5 is an illustration of a pool cleaning robot apparatus connected to a buoyant rechargeable battery power source equipped with a solar panel, according to an embodiment of the present invention.

FIG. 6 is a flowchart of a method of adapting an operation mode for a pool cleaning robot, according to an embodiment of the present invention.

FIG. 7 is a block diagram of an exemplary computing device which may be used with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

The term “mains electricity” generally refers to a general-purpose alternating current electric power supply (also known as “domestic power” “the electric grid” etc.) that is delivered to homes and businesses through an electric grid.

According to some embodiments, there is provided a pool cleaning robot apparatus comprising: a housing; a pump for drawing liquid from the pool into the housing through an inlet and expelling the liquid through an outlet when the pool cleaner is submerged in the pool; a filter for trapping debris that is in the indrawn liquid; a propulsion system for propelling the pool cleaning robot along a submerged surface within the pool; and a control system configured to: identify a type of a power source when connected to the power source, the type being either a main electricity driven power source or a rechargeable battery, and based on the identified type of the power source, select an operation mode for the pool cleaning robot associated with the identified type of the power source.

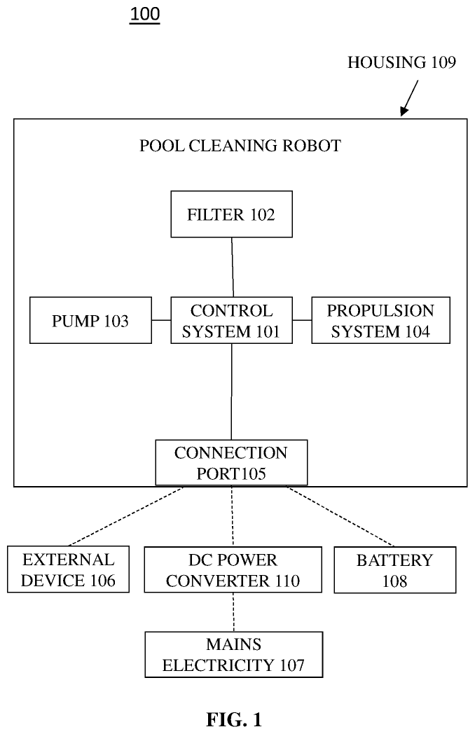

FIG. 1 shows a block diagram of a pool cleaning robot apparatus 100, according to an embodiment of the present invention. Pool cleaning robot 100 comprises a housing 109, a pump 103 for drawing liquid from the pool into the housing through an inlet and expelling the liquid through an outlet when the pool cleaner is submerged in the pool; a filter 102 for trapping debris that is in the indrawn liquid; a propulsion system 104 for propelling the pool cleaning robot along a submerged surface within the pool; and a control system 101. The control system may further be connected to connection port 105. Connection port 105 may be connected to mains electricity 107 via DC power converter 110. Connection port 105 may be connected, e.g., by an electrical cable, to a battery 108. Battery 108 may be a rechargeable battery. In an embodiment, battery 108 may be a battery pack. In the following description reference is made to “rechargeable battery”, but it is noted and understood that a battery that is not rechargeable may be used in some embodiments of the present invention. Additional connection port 109 may be used for connecting, e.g., via an electrical cable, an external device 106. In some embodiments, control system 101 is configured to detect a type of a power source when connected to the power source, the type being either a main electricity power source 107 or a battery 108. In some embodiments, based on the identified type of the power source, control system 101 is further configured to select an operation mode for the pool cleaning robot associated with the identified type of the power source.

For example, a propulsion system of the pool cleaning robot may be configured to propel the pool cleaning robot back and forth along a surface of the pool. The propulsion system may include a motor that is configured to drive wheels, brushes and other components to propel the pool cleaning robot over the floor and walls of the pool. A drive motor may be connected to a propulsion wheel or other component via a transmission that may include one or more pulleys, pinions, or gears.

For example, a pump may force water to flow into the pool cleaning robot. The pump may be located either inside a housing of the pool cleaning robot, or may be mounted outside of the housing, thereby applying suction. The water is indrawn via an inlet and is then drawn through a filter that traps any debris in the indrawn water. In some cases, the filter may include a mesh or a filter bag that traps debris in a chamber that is located inside the housing or housed within an exterior cover of the pool cleaning robot. The pump may further be configured to expel the filtered water through an outlet of the pool cleaning robot. In some cases, the outlet is located on a top surface of the pool cleaning robot, e.g., on a surface that faces away from an interior surface of the pool along which the pool cleaning robot is being propelled.

In various embodiments, the control system is configured, in detecting the type of the power source, to perform one or more of: identify a serial communication received from the connected power source indicative of the type of the power source; detecting an input voltage indicative of the type of the power source received from the connected power source; and detecting a voltage sequence indicative of the type of the power source received from the connected power source. In some embodiments, the type of the power source is detected by identifying a serial communication received from the connected power source; detecting an input voltage received from the connected power source; and detecting a voltage sequence received from the connected power source.

In some embodiments, the apparatus comprises a connection port and one or more of: serial communication, input voltage and voltage sequence of the connected power source, are received via the connection port. The connection port may be located on or in the housing of the apparatus.

In some embodiments, serial communication refers to the identification of data received by the control system, for example via a connection port of the apparatus. In some embodiments, the received data may provide information that allows the identification of the power source. For example, a computing device located within a rechargeable battery connected to the control system may provide the control system with data via serial communication and thereby, may provide the control system with data specifying the type of battery attached to the control system, the charging state of the rechargeable battery or the number of cycles the rechargeable battery has been charged. For example, the charging state of the rechargeable battery may be transmitted from the rechargeable battery to the control system once every minute.

In various embodiments, detecting the input voltage of the power source or detecting the voltage sequence of the power source by the control system includes measuring the voltage or voltage sequence of the power source supplied to the control system, for example at the connection port of the apparatus:

During mains electricity power supply, the adaptable robot may be connected, e.g. via a cable such as a floating cable, to a mains electricity direct current (DC) power converter. The mains electricity DC power converter may be connected to mains electricity, e.g. via a mains electricity socket of a house, and converts alternating current (AC) electricity provided by mains electricity to DC electricity that is supplied to the adaptable robot. As it is known in the art, the low voltage contact limit for the construction and installation of electric wiring and equipment associated with swimming pools is limited to a voltage not exceeding a voltage of 30 V for DC electricity supply. Thus, the power supply to the adaptable robot is limited to an input voltage of 30 V DC. The generated mains DC voltage via a mains electricity DC power converter provides a constant energy supply and withstands very high robot's power consumption. The constant energy supply may allow the adaptable robot to be used for an indefinite amount of time, only limited by the user disconnecting the power supply, without restricting its functionalities. The control system of the adaptable robot disclosed herein may identify a change in the detected voltage levels, e.g. at a connection port of the robot, in a pre-programmed sequence during the supply of electricity to the robot. The pre-programmed sequence in voltage levels may be generated by mains electricity DC power converter, e.g. power converter 110. For example, the pre-programmed sequence includes a short sequence of voltage switches such as a voltage of 30 V DC for 0.25 seconds duration, followed by 24 V DC for 0.25 seconds, followed by a 20 V DC for 0.25 seconds. At the start of the electricity supply to the robot, the sequence may be detected by the control system at a connection port of the adaptable robot and can be used to identify the power source as a DC voltage supply generated from mains electricity. Accordingly, upon detection of an input voltage sequence as outlined above, the control system adapts the operation mode of the robot to mains electricity operation mode.

Power supply using a rechargeable battery, e.g. battery 108, does not require the modulation of energy supplied to an adaptable robot, e.g. via connection port 105 of robot 100, since electricity provided by a battery connecting to the adaptable robot is always DC electric charge. Thus, when the adaptable robot is connected to a rechargeable battery, upon power up, the control system may detect a short sequence of voltage switches supplied by the rechargeable battery to the robot that is characteristic for the power supply by a rechargeable battery. Accordingly, the control system adapts the operation mode of the robot to battery operation mode.

The mains electricity power supply is effectively limitless, allowing a pool cleaning robot to operate for long hours. Therefore, pool cleaning robots powered by mains electricity power supply may be configured to perform various maneuvers when sweeping the pool, effectively covering the entire surface of the pool or extensive parts of it thereon. In contrast, a battery is substantially more limited in supplying power. Therefore, pool cleaning robots powered by a battery may be configured to perform a more limited number of maneuvers inside the pool and may therefore be more limited in covering areas of the pool when sweeping the pool.

A control system of a pool cleaning robot according to some embodiments of the present invention, upon detecting the type of power supply powering the pool cleaning robot may, based on the identified type of the power source, select an operation mode for the pool cleaning robot associated with the identified type of the power source that is suitable for that type of power source. For example, upon identifying the power source to be a mains electricity power source, the control system may cause the pool cleaning robot to execute a sweeping program that runs until a user stops it or for a first predetermined of time (e.g., large number of operating hours). Alternatively, upon identifying the power source to be a battery power source, the control system may cause the pool cleaning robot to execute a sweeping program that runs for a second predetermined period of time which is shorter than the first period of time.

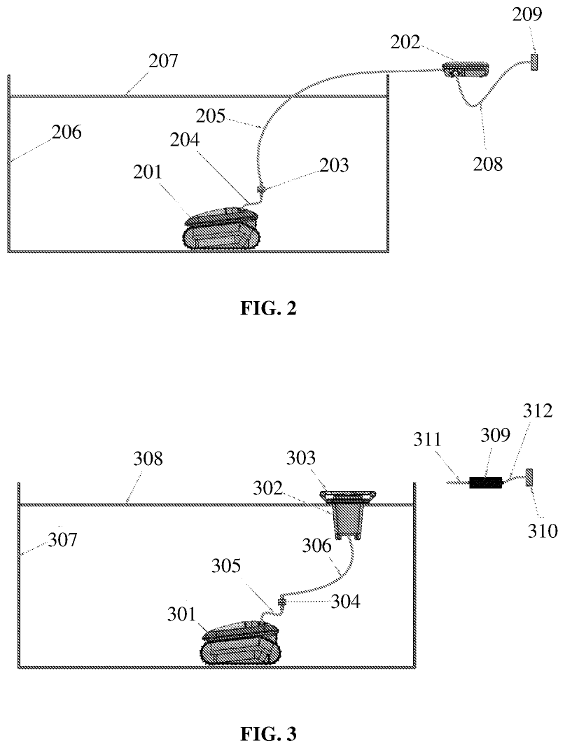

FIG. 2 is an illustration of a pool cleaning robot apparatus 201 in a swimming pool 207 that is connected to mains electricity power supply, according to an embodiment of the present invention. Pool cleaning robot 201 is connected via a cable 205, to the mains electricity DC power converter 202 receiving its AC power via power cord 208 and wall socket 209 The mains electricity power supply may be commonly characterized by an alternating current and a typical voltage of 230 V or 110 V. The operation system of the pool cleaning robot may include a 202 converter for converting the supplied electricity to a direct current and a voltage of below 30 V to power the robot. The connection from power cord 208 may be made using floating cable 205. Floating cable 205 may be directly connected to robot 201 or to a shorter floating cable 204 extending form robot 201 using a water tight connector 203 as depicted in FIG. 2. The control system of the pool cleaning robot may be located in an impervious housing, e.g. a drive unit box. The housing may include a control system comprising a controller, one or more drive motors and a pump, e.g. a water suction pump. In some embodiments, the pool cleaning robot may further comprise a cleaning brush located at the outside of the housing and connected to the control system. When operating, the control system drives the robot according to a preprogrammed scanning algorithm, swiping the floor and side walls 206 with its rotating brushes. The duration of the pool cleaning cycle may be preprogrammed, typically 1.5-2.5 hours for a medium size swimming pool when connected to mains electricity power supply. At the cleaning cycle end, the robot stops, and may need to be extracted from the pool to clean its filter.

FIG. 3 is an illustration of an apparatus according to an embodiment of the present invention. The pool cleaning robot 301 is shown on the floor of a pool, connected with a short (e.g., one meter long) floating cable 305 to another short (e.g., one meter long) floating cable 306, via a water tight connector 304. This provides electrical connection between the robot 301 and a buoyant rechargeable battery 302, floating atop the water line 317. The rechargeable battery 302 supplying electrical power to the robot 301 may include a water tight compartment 303.

After identification of the type of power source, the control system may select an operation mode for the pool cleaning robot associated with the identified type of the power source. In some embodiments, each operation mode is associated with a setting for one or more control parameters of the control system. In some embodiment, the operation mode is an operation mode under mains electricity. For example, the pool cleaning robot is connected using a power cable to a socket of a house. In some embodiments, the operation mode is an operation mode using a rechargeable battery.

The operation mode may lead to an adjustment of one or more of the control parameters.

In some embodiments, the control parameters of the control system comprise one or more of: floor pump speed; floor drive motor; climbing pump speed; climbing wall frequency; climbing drive motor; climbing wall speed; water line scrubbing time; water line scrubbing intensity; cleaning time; PID control of drive motors; PID control of pump motors; wall climbing parameters; water line detection parameters; drain detection parameters; obstacle release process parameters; and scanning algorithm parameters.

In some embodiments, the control system may cause the floor speed and/or the wall climbing speed of the robot to be adjusted based the operation mode.

In some embodiments, water line scrubbing time may be adjusted based on the operation mode.

In some embodiments, the water line scrubbing intensity may be adjusted based on the operation mode.

In some embodiments, the cleaning time may be adjusted based on the operation mode.

In some embodiments, the PID control of drive motors may be adjusted based on the operation mode.

In some embodiments, the PID control of pump motors may be adjusted based on the operation mode.

In some embodiments, the wall climbing parameters may be adjusted based on the operation mode.

In some embodiments, the drain detection parameters may be adjusted based on the operation mode.

In some embodiments, the climbing wall frequency may be adjusted based on the operation mode.

In some embodiments, the obstacle release process parameters may be adjusted based on the operation mode.

In some embodiments, the scanning algorithm parameters may be adjusted based on the operation mode.

For example, in the battery operation mode using a rechargeable battery, the robot is supplied with a limited amount of electricity stored within the batteries. Thus, in the battery operation mode, the robot may be adapted to operate under low energy consumption: The energy consumption of the pool cleaning robot may be reduced by the control system reducing the floor speed and/or the wall climbing speed of the robot. For example, the floor speed and/or wall climbing speed of the robot in battery operation mode may be reduced to between 75%-90% of the speed used under mains electricity power supply. The energy consumption of the pool cleaning robot may be reduced by the control system reducing the water line scrubbing time of the robot. The energy consumption of the pool cleaning robot may be reduced by the control system reducing the water line scrubbing intensity of the robot. The energy consumption of the pool cleaning robot may be reduced by the control system reducing the cleaning time of the robot. The energy consumption of the pool cleaning robot may be reduced by the control system reducing the PID compensation parameters of drive motors of the robot. The energy consumption of the pool cleaning robot may be reduced by the control system reducing the PID control of pump motors of the robot. The energy consumption of the pool cleaning robot may be reduced by the control system reducing the frequency of wall climbing of the robot. For example, the frequency of wall climbing of the robot in battery operation mode may be reduced to between 75%-90% of the speed used under mains electricity power supply. The energy consumption of the pool cleaning robot may be reduced by the control system reducing the drain detection parameters of the robot. The energy consumption of the pool cleaning robot may be reduced by the control system reducing the climbing wall frequency of the robot. The energy consumption of the pool cleaning robot may be reduced by the control system reducing the obstacle release process parameters of the robot. The energy consumption of the pool cleaning robot may be reduced by the control system reducing the scanning algorithm parameters of the robot.

In various embodiments, selecting the operation mode for the pool cleaning robot comprises adjusting one or more control parameters of: operation cycle duration; power consumption; and floor time.

In some embodiments, the operation cycle duration may be adjusted depending on the operation mode of the pool cleaning robot. In some embodiments, the operation cycle during mains electricity operation mode is of undefined length since the mains electricity power supply practically offers an unlimited electricity supply. In some embodiments, in the mains electricity operation mode, the operation cycle may be interrupted by a signal received at the control system from a user using a signaling device, e.g. a remote control connected to the control system, e.g. via Bluetooth. In some embodiments, the operating cycle during the battery operation mode is adjusted to one operating cycle. In some embodiments, the length of the operating cycle of the pool cleaning robot in the battery operation mode is dependent on the capacity of the rechargeable battery. Transmittal of the charging state of the rechargeable battery via a computing device located at the rechargeable battery or a sensor may provide the charging state of the rechargeable battery to the control system at distinct time intervals during operation of the pool cleaning robot. For example, time intervals for the provision of the charging state of the rechargeable battery to the control system may be once every second or once every minute.

In some embodiments, the power consumption is adjusted depending on the operation mode of the pool cleaning robot. In some embodiments, the power consumption during the mains electricity operation mode is unrestricted since the mains electricity power supply has an unlimited electricity supply. Thus, the control system may allow connected external devices full functionality during the mains electricity operation mode. In some embodiments, the power consumption during the battery operation mode is restricted to the amount of energy stored by the external battery. In an embodiment, the pool cleaning robot has an increased energy consumption when external devices are connected to the pool cleaning robot. Thus, the control system may limit the functionality of connected external devices during the battery operation mode.

In some embodiments, the floor time of the pool cleaning robot is adjusted depending on the operation mode. The floor time may relate to the time that a robot operates on the ground of a pool. In some embodiments, the floor time during the mains electricity operation mode is of undefined length since the mains electricity power supply has an unlimited electricity supply. In some embodiments, the floor time during the battery operation mode is adjusted to an amount of time that allows the pool cleaning robot to take a position in which the pool cleaning robot can be removed from the pool before the rechargeable battery is discharged. In some embodiments, the floor time of the pool cleaning robot in the battery operation mode is dependent on the capacity of the rechargeable battery.

In some embodiments, the rechargeable battery is separate from the housing. In some embodiments, the rechargeable battery is buoyant. During operation of the pool cleaning robot, the buoyant rechargeable battery connected to the pool cleaning robot may be pulled across the water surface of the pool due to the movement of the pool cleaning robot at the floor of the pool, e.g. as depicted in FIG. 3. Due to the short connection between pool cleaning robot and the buoyant battery (around 1 m cable length), the movement of the pool cleaning robot during operation may be less restricted compared to power supply via a floating cable connected to mains electricity outside of the pool.

In some embodiments, the control system is configured to detect and identify external devices connected to the pool cleaning robot. In an embodiment, an external device is a device that is connected to the pool cleaning robot via a connection cable. For example, a connection cable may be a short floating cable (about 1 m length) extending from the pool cleaning robot's housing. The external device may allow the pool cleaning robot to perform an additional functionality. In an embodiment, an external device may be a rechargeable battery. In an embodiment, an external device may be a buoyant rechargeable battery. In various embodiments, an external device may be a skimming device, a solar panel or a buoyant light source information.

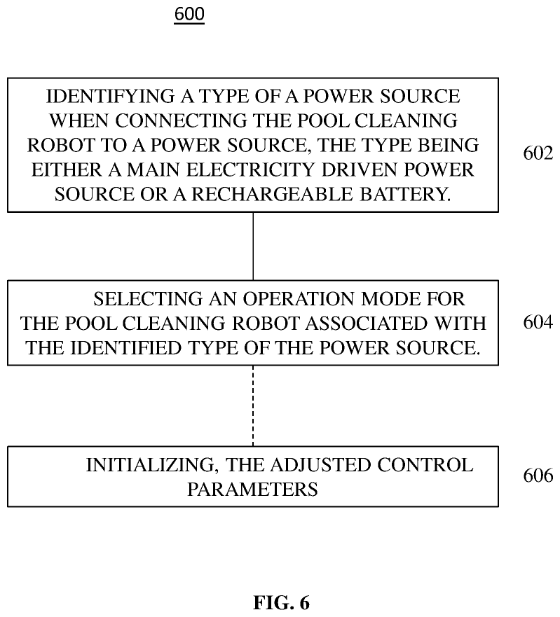

For example, a pool cleaning robot can be connected to a buoyant light source and/or a data display. The buoyant light source and/or a data display may enable users to receive visual information regarding the condition of the cleaning state of the pool and/or the robot performance. For example, once connected to the pool cleaning robot via a short cable, the buoyant light source may be identified by the control system via serial communication between the controller of the control system and a computing device present in the buoyant light source (as outlined in step 601 of FIG. 6 below). Once the control system of the pool cleaning robot has identified the connection to the buoyant light source, the control system of the pool cleaning robot automatically adapts its operation mode to enable the provision of data regarding the cleaning state of the pool and/or the robot performance to the computing device present in the buoyant light source (step 602 of FIG. 6 below): For example, the control system of the pool cleaning robot transmits to the computing device present in the buoyant light source information regarding the charging state of an external rechargeable battery. A light source present at the buoyant light source may change its color depending on the charging state so a user next to the pool might have a visual information on the charging level of the batteries. In an alternative example, a sensor at the filter of the pool cleaning robot may transmit to the control system of the pool cleaning robot information regarding the amount of debris collected in the filter. The control system may transmit to the computing device present in the buoyant light source information regarding the amount of debris collected in the filter. The light source present at the buoyant light source may indicate via visual information, e.g. a flashing light that the filter of the pool cleaning robot is empty or whether it requires cleaning.

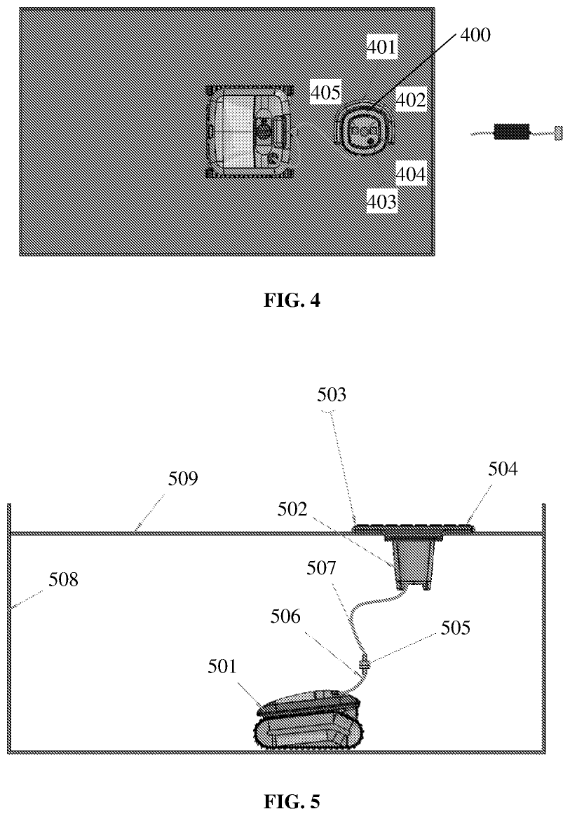

FIG. 4 is a top view illustration of the top cover of the water tight compartment 401, and provides an alternative rechargeable battery 400 to rechargeable battery 302 previously shown in FIG. 3. The water tight compartment 401 surrounding rechargeable battery 400 may comprise an ON/OFF power switch 402, a water tight charging connector 403 and lights for Bluetooth ON 404, and clogged filter bag indications 405. ON/OFF power switch 402 may enable to transmit a power on command to a computing device of the rechargeable battery to switch on power supply to the robot using wireless signaling, e.g. using Bluetooth communication. Filter bag indication 405 may be connected to the control system of the pool cleaning robot, e.g. pool cleaning robot 101 as shown in FIG. 1. For example, during operation, a sensor at the filter bag of a filter of the pool cleaning robot, e.g. filter 102 (as shown in FIG. 1), may transmit serial information to a control system, e.g. control system 101 (as shown in FIG. 1), in relation to the amount of water being filtered by filter 102. If the sensor located at the filter bag identifies a clogged filter bag, it may transmit a serial information related to a clogged filter to the control system. The control system may receive the serial information related to a clogged filter and sends a signal to a computing device located with compartment 401, and clogged filter bag indication 405 is triggered. This visual indication may allow a user to identify the fault in the filter and can stop the operation mode of the pool cleaning robot.

In a further example, a pool cleaning robot can be connected to a buoyant, external skimming device. For example, once connected to the pool cleaning robot via a short cable, the external skimming device may be identified by the control system, e.g. via serial communication between the controller of the control system and a computing device in the external skimmer (as outlined in step 601 of FIG. 6 below). Once the control system of the pool cleaning robot has identified the connection to the external skimming device, the control system of the pool cleaning robot automatically adapts its operation mode to the presence of an external skimming device (step 602 of FIG. 6 below): For example, the control system of the pool cleaning robot when connected to an external skimming device and receiving power supply via an external battery, may recalculates its power consumption taking into the requirement to provide energy to the external skimming device and may adapt its remaining battery capacity to the enhanced power consumption due to the connected skimmer. Additionally, the control system may transmit to the skimming device a skimming operation mode that is adapted to battery power supply of the pool cleaning robot. In some embodiments, a skimming operation mode under battery power supply may result in a reduced suction of the pump of the skimmer to allow the pool cleaning robot to reduce its energy consumption. In some embodiments, a skimming operation mode under mains electricity power supply may result in a suction of the pump of the skimmer that is not reduced compared to the battery operation mode since the energy consumption of the pool cleaning robot proceeds via mains electricity.

In FIG. 5, a robot 501 is located on the pool's floor and is connected to a water tight compartment 502 via short floating cables 506, 507 and connector 505. This water tight compartment is equipped with a solar panel 504. Solar Panel 504 may be connected to a rechargeable battery inside of water tight compartment 502. Upon operation, Solar Panel 504 may supply energy to the rechargeable battery, which avoids the need to recharge the batteries too often or enables longer operation cycles before charging. The presence of a Solar Panel 504 in connection to the rechargeable batteries may be detected by the control system of a pool cleaning robot, e.g. robot 501, and the robot may adapt its mode of operation to the presence of a solar panel, e.g. Solar Panel 504.

FIG. 6 shows a method for adapting an operation mode for a pool cleaning robot, according to some embodiments of the invention. According to some embodiments, method 600 includes, using a controller of the control system, identifying a type of a power source when connecting the pool cleaning robot to a power source, the type being either a main electricity driven power source or a rechargeable battery (step 602).

In various embodiments, identifying a type of a power source comprises performing one or more of: identifying a serial communication received from the connected power source; detecting an input voltage received from the connected power source; and detecting a voltage sequence received from the connected power source.

In some embodiments, the type of power source is identified at a connection port connected to the control system and the one or more of: serial communication, input voltage and voltage sequence of the connected power source, are received via the connection port.

In some embodiments, the type of power source is identified at a connection port connected to the control system and the one or more of: serial communication, input voltage and voltage sequence of the connected power source, are received via the connection port.

Turning back to FIG. 6, according to some embodiments, method 600 includes using the controller of the control system, based on the detected type of the power source, selecting an operation mode for the pool cleaning robot associated with the identified type of the power source (step 604). In some embodiments, the operation mode for the pool cleaning robot is a mains electricity operation mode. In some embodiments, the operation mode for the pool cleaning robot is a battery operation mode.

In some embodiments, selecting the operation mode comprises adjusting one or more control parameters of the control system. In some embodiments, adjusting one or more control parameters of the control system comprises adjusting one or more of: floor pump speed; floor drive motor; climbing pump speed; climbing wall frequency; climbing drive motor; climbing wall speed; water line scrubbing time; water line scrubbing intensity; cleaning time; PID control of drive motors; PID control of pump motors; wall climbing parameters; water line detection parameters; drain detection parameters; obstacle release process parameters; and scanning algorithm parameters.

In some embodiments, selecting the operation mode for the pool cleaning robot comprises selecting the operation mode for one or more control parameters of the control system configured to control one or more of: propulsion system; water inlets; water outlets; filters; and pumps.

In some embodiments, the method further comprises the step of, using the controller of the control system, initializing, the adjusted control parameters (step 606). In the initializing step, the controller of the control system may provide the pump, the filter and the propulsion system with the setting for one or more control parameters. In an embodiment, the controller of the control system provides the external devices with a setting for the one or more control parameters.

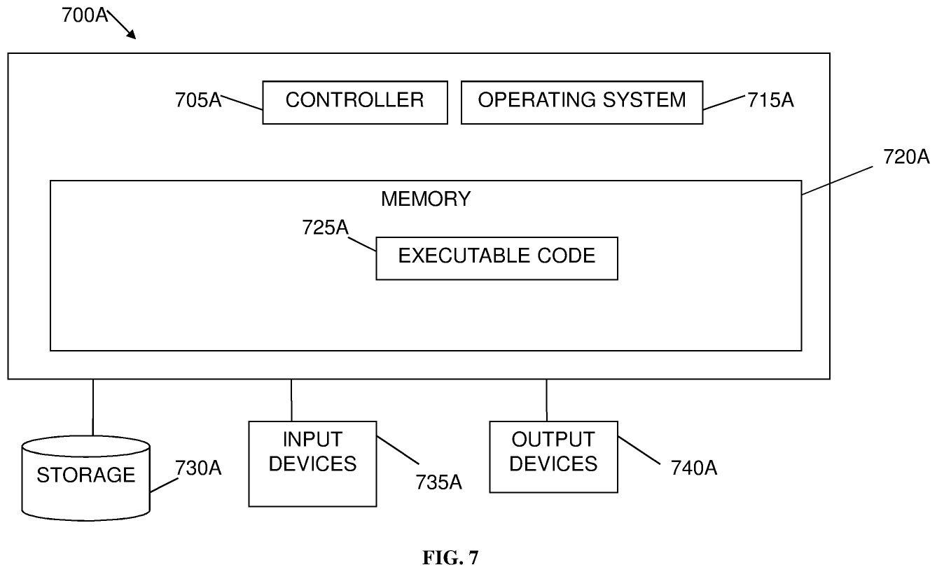

Referring back to FIG. 1, control system 101, filter 102, pump 103, propulsion system 104, connection port 105, external device 106 and rechargeable battery 108 as disclosed in FIG. 1 may comprise a computing device 700A as shown in FIG. 7.

FIG. 7 shows a block diagram of an exemplary computing device which may be used with embodiments of the present invention. Computing device 700A may include a controller or computer processor 705A that may be, for example, a central processing unit processor (CPU), a chip or any suitable computing device, an operating system 715A, a memory 720A, a storage 730A, input devices 735A and output devices 740A such as a computer display or monitor displaying for example a computer desktop system.

Operating system 715A may be or may include code to perform tasks involving coordination, scheduling, arbitration, or managing operation of computing device 700A, for example, scheduling execution of programs. Memory 720A may be or may include, for example, a Random Access Memory (RAM), a read only memory (ROM), a Flash memory, a volatile or non-volatile memory, or other suitable memory units or storage units. At least a portion of Memory 720A may include data storage housed online on the cloud. Memory 720A may be or may include a plurality of different memory units. Memory 720A may store for example, instructions (e.g. code 725A) to carry out a method as disclosed herein. Memory 720A may use a datastore, such as a database.

Executable code 725A may be any application, program, process, task, or script. Executable code 725A may be executed by controller 705A possibly under control of operating system 715A. For example, executable code 725A may be, or may execute, one or more applications performing methods as disclosed herein, such as a machine learning model, or a process providing input to a machine learning model. In some embodiments, more than one computing device 700A or components of device 700A may be used. One or more processor(s) 705A may be configured to carry out embodiments of the present invention by for example executing software or code.

Storage 730A may be or may include, for example, a hard disk drive, a floppy disk drive, a compact disk (CD) drive, a universal serial bus (USB) device or other suitable removable and/or fixed storage unit. Data described herein may be stored in a storage 730A and may be loaded from storage 730A into a memory 720A where it may be processed by controller 705A. Storage 730A may include cloud storage. Storage 730A may include storing data in a database.

Input devices 735A may be or may include a mouse, a keyboard, a touch screen or pad or any suitable input device or combination of devices. Output devices 740A may include one or more displays, speakers and/or any other suitable output devices or combination of output devices. Any applicable input/output (I/O) devices may be connected to computing device 700A, for example, a wired or wireless network interface card (NIC), a modem, printer, a universal serial bus (USB) device or external hard drive may be included in input devices 735A and/or output devices 740A.

Embodiments of the invention may include one or more article(s) (e.g. memory 720A or storage 730A) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A pool cleaning robot apparatus comprising:
a housing;
a pump for drawing liquid from the pool into the housing through an inlet and expelling the liquid through an outlet when the pool cleaner is submerged in the pool;
a filter for trapping debris that is in the indrawn liquid;
a propulsion system for propelling the pool cleaning robot along a submerged surface within the pool; and
a control system configured to:
detect a type of a power source when connected to a power source, the type being either a main electricity power source or a battery, and
based on the identified type of the power source, select an operation mode for the pool cleaning robot associated with the identified type of the power source.

2. The apparatus according to claim 1, wherein the control system is further configured to operate the pool cleaning robot in the selected operation mode.

3. The apparatus according to claim 1, wherein the battery is a rechargeable battery.

4. The apparatus according to claim 1, wherein the control system is configured, in detecting the type of the power source, to perform one or more of:
(a) identify a serial communication received from the connected power source;
(b) detecting an input voltage received from the connected power source; and
(c) detecting a voltage sequence received from the connected power source.

5. The apparatus according to claim 4, comprising a connection port and the one or more of serial communication, input voltage and voltage sequence of the connected power source, are received via the connection port.

6. The apparatus according to claim 1, wherein each operation mode is associated with a setting for one or more control parameters of the control system.

7. The apparatus according to claim 6, wherein the control parameters of the control system comprise one or more of:
(a) floor pump speed;
(b) floor drive motor;
(c) climbing pump speed;
(d) climbing wall frequency;
(e) climbing drive motor;
(f) climbing wall speed;
(g) water line scrubbing time;
(h) water line scrubbing intensity;
(i) cleaning time;
(j) PID control of drive motors;
(k) PID control of pump motors;
(l) wall climbing parameters;
(m) water line detection parameters;
(n) drain detection parameters;
(o) obstacle release process parameters; and
(p) scanning algorithm parameters.

8. The apparatus according to claim 1, wherein the battery is separate from the housing.

9. The apparatus according to claim 1, wherein the battery is buoyant.

10. The apparatus according to claim 1, wherein the control system is configured to detect and identify external devices connected to the pool cleaning robot.

11. A method for adapting an operation mode for a pool cleaning robot, the method comprising:
using a controller of the control system, identifying a type of a power source when connecting the pool cleaning robot to a power source, the type being either a main electricity power source or a battery; and
using the controller of the control system, based on the detected type of the power source selecting an operation mode for the pool cleaning robot associated with the identified type of the power source.

12. The method according to claim 11, further comprising operating the pool cleaning robot in the selected operation mode.

13. The method according to claim 11, wherein the battery is a rechargeable battery.

14. The method according to claim 11, wherein identifying a type of a power source comprises performing one or more of:
(a) identifying a serial communication received from the connected power source;
(b) detecting an input voltage received from the connected power source; and
(c) detecting a voltage sequence received from the connected power source.

15. The method according to claim 11, wherein the type of power source is identified at a connection port connected to the control system and the one or more of: serial communication, input voltage and voltage sequence of the connected power source, are received via the connection port.

16. The method according to claim 11, wherein selecting the operation mode comprises adjusting one or more control parameters of the control system.

17. The method according to claim 16, wherein adjusting one or more control parameters of the control system comprises adjusting one or more of:
(a) floor pump speed;
(b) floor drive motor;
(c) climbing pump speed;
(d) climbing wall frequency;
(e) climbing drive motor;
(f) climbing wall speed;
(g) water line scrubbing time;
(h) water line scrubbing intensity;
(i) cleaning time;
(j) PID control of drive motors;
(k) PID control of pump motors;
(l) wall climbing parameters;
(m) water line detection parameters;
(n) drain detection parameters;
(o) obstacle release process parameters; and
(p) scanning algorithm parameters.

18. The method according to claim 16, wherein selecting the operation mode for the pool cleaning robot comprises adjusting one or more control parameters of:
(a) operation cycle duration;
(b) power consumption; and
(c) floor time.

19. The method according to claim 11, wherein selecting the operation mode for the pool cleaning robot comprises selecting the operation mode for one or more control parameters of the control system configured to control one or more of:
(a) propulsion system;
(b) water inlets;
(c) water outlets;
(d) filters; and
(e) pumps.

20. The method according to claim 11, wherein the rechargeable battery is separate from the housing.

21-23. (canceled)
